(19) United States
(12) Patent Application Publication
(10) Pub. No.: US 2023/0166555 A1
(43) Pub. Date: Jun. 1, 2023

(54) DATA CARRIER WITH PROTECTION AGAINST SUGSEQUENT LASER MARKING

(71) Applicant: THALES DIS FRANCE SAS, MEUDON (FR)

(72) Inventors: Christian SAILER, Safenwil (CH); Stefan EGLI, Uster (CH)

(73) Assignee: THALES DIS FRANCE SAS, MEUDON (FR)

(21) Appl. No.: 17/912,892

(22) PCT Filed: Apr. 9, 2021
(86) PCT No.: PCT/EP2021/059337

§ 371 Date: Sep. 20, 2022

(30) Foreign Application Priority Data
Apr. 9, 2020 (EP) 20169033.6

(51) Int. Cl. B42D 25/41; B42D 25/328; B42D 25/324

(52) U.S. Cl. CPC B42D 25/41; B42D 25/328; B42D 25/324; B42D 25/382

(57) ABSTRACT

Provided is a data carrier comprising a card body, wherein the card body is configured to interact with impinging electromagnetic radiation (R) such, that a laser marking (M1) having a first appearance (A1) is generated in the card body in the region of impingement. The data carrier further comprises at least one protection element that is configured to interact with impinging electromagnetic radiation (R) such, that a laser marking (M2) having a second appearance (A2) is generated in the card body, wherein said second appearance (A2) differs from the first appearance (A1).

### TECHNICAL FIELD

The present invention relates to a data carrier according to claim 1, to a security document comprising such a data carrier according to claim 13, and to a method of producing a data carrier according to claim 15.

### PRIOR ART

Data carriers used in security documents such as identity cards or passports generally comprise information on the holder. For example, it is very common to provide the data carrier with the name, nationality, date of birth or an image of the holder. To this end, various ways are known by means of which said information can be added to or generated in the data carrier. Often, this so-called personalization is performed by choosing a material of the data carrier that is sensitive to laser radiation. In this case, the information can simply be written into the material of the data carrier by irradiating laser radiation, whereby laser marks constituting the information are generated. However, this laser-added information is typically not protected against an alteration based on a subsequent, additive laser marking. That is, a forger could simply add information such as a beard on a man's face if needed for imposter. Another example of forgery could be an overwriting of a light laser engraved picture, e.g. from a person with a light skin tone and blond hair, with a darker picture corresponding to another person.

### SUMMARY OF THE INVENTION

It is an object of the present invention to provide a data carrier that has an increased protection against forgery.

This object is achieved with a data carrier according to claim 1. In particular, a data carrier is provided, which comprises a card body. The card body is configured to interact with impinging electromagnetic radiation such, that a laser marking having a first appearance is previously generated in the card body in the region of impingement in the absence of a protection element. The data carrier further comprises at least one protection element. The at least one protection element is configured to interact with impinging electromagnetic radiation such, that a laser marking having a second appearance is generated in the card body, wherein said second appearance differs from the first appearance.

That is to say, the card body comprises a radiation sensitive material such that a laser marking having a first appearance is generated upon irradiation of the card body with electromagnetic radiation. In this way original information such as a name, nationality, a date, a flag, a national coat of arms, an image or photograph, etc., can be written into the data carrier. If a forger then tries to manipulate this original information by irradiating electromagnetic radiation onto the data carrier, the protection element interacts with said electromagnetic radiation in a way that a laser marking having a different appearance than the appearance of the original laser marking is generated. Because of this different appearance the forgery becomes readily apparent. Consequently, the protection element according to the invention confers an increased protection against forgery.

The card body preferably corresponds to a card body as it is known in the art. Hence, the card body can comprise one or more layers, wherein at least one of which is configured to interact with electromagnetic radiation under the generation of a laser marking. Such a layer is herein referred to as processing layer. Conceivable layers are transparent layers, preferably plastic layers, particularly preferably thermoplastic layers such as polycarbonate (PC), polyvinyl chloride (PVC), amorphous polyester (A-PET), co-polyester (PET-G) polyethylene terephthalate (PET), or biaxially-oriented polyethylene terephthalate (boPET).

An irradiation of electromagnetic radiation will result in a blackening of the irradiated layer at the location of irradiation. The blackening is typically based on a material carbonization mainly in the transparent layers, often reinforced by laser additives when plastic layers are used in the data carrier. This technique is a standard process and widely used in the plastics industry. In the absence of at least one protection element according to the invention said blackening will be of a precise and/or well-defined shape. This precise shape can be understood in the context of the present invention as a laser marking having a first appearance. However, in the presence of the protection element, it is no longer possible for a forger to generate a laser marking that has this precise and/or well-defined shape. Instead, and as will be explained in greater detail further below, a disturbed, blurry or imprecise darkening results, which is herein referred to as a laser marking having a second appearance. The card body can comprise one or more further layers, such as an opaque layer that is arranged below the at least one processing layer mentioned above with respect to an extension direction. The one or more opaque layers can correspond to opaque plastic layers, for example an opaque polycarbonate layer. Any further layers as they are known in the state of the art are of course likewise conceivable.

The at least one protection element is preferably provided on the card body, particularly preferably on top, i.e. on an uppermost surface of the card body. The arrangement of the protection element on the card body, in particular on top of the card body, brings the advantage of a simple application. In fact, it could simply be added on top of a data carrier that has already been provided with the original laser marking.

The at least one protection element can be configured to generate one or more gases upon an interaction with electromagnetic radiation. In this case, if a forger irradiates electromagnetic radiation onto the data carrier, the protection element will interact with the irradiated electromagnetic radiation under the generation of gas. The generated gas can lead to bubbles, bulges, strong blackening, striking color shades, bleeding, blurry or fuzzy laser markings.

The at least one protection element can be configured to diffract and/or scatter and/or deflect impinging electromagnetic radiation. Hence, if a forger irradiates electromagnetic radiation onto the data carrier, the protection element will interact with the irradiated electromagnetic radiation such that it is diffused or partly reflected, for example. As a result, a blurry and imprecise laser marking is achieved.

The at least one protection element can be configured to absorb electromagnetic radiation, preferably electromagnetic radiation being in the ultraviolet region and/or in the infrared region of the electromagnetic spectrum. Upon irradiation of electromagnetic radiation by a forger, such a protection element will at least partly block the irradiated electromagnetic radiation. Consequently, a blurry and imprecise laser marking is achieved. Additionally or alternatively the at least one protection element can be configured to exhibit an adhesive force. However, it is likewise conceivable that the protection element does not exhibit any adhesive force. To this end, it is preferred to provide the protection element as a combination of a composition being configured to absorb electromagnetic radiation as well as a composition being configured to establish an adhesive force that is lower, or not even present, as compared to an adhesive force established in its surroundings. Such a combination leads to the bleeding-effect mentioned earlier. In fact, the bleeding-effect results because of weak adhesion properties established between e.g. two successive layers in combination with strong absorption properties. Because of the strong absorption properties an increased local heating of the material and a resulting material combustion is achieved. This in turn results in gas formation and blackening, which spreads in the regions with weak adhesion or no adhesion (“bleeding”), whereby a subsequent laser marking is made obvious. Examples of conceivable chemical compositions are given further below.

The at least one protection element preferably comprises at least one of a laser reactive pigment, laser reactive additive, and laser reactive colorant. If these components are irradiated with electromagnetic radiation gases are produced that result in the bubbles or bulges mentioned above. These components are commercially available, wherein a conceivable component is the red UV fluorescent ink provided by the company Sicpa with the item code 3Z0U13F, for example.

The data carrier can further comprise at least one personalization item such as an alphanumeric character and/or an image, and wherein the personalization item comprises the at least one protection element and an ink, preferably an inkjet ink.

That is to say, it is conceivable to simply add the protection element, preferably a laser reactive pigment and/or a laser reactive additive and/or a laser reactive colorant and/or a particle being configured to diffract and/or scatter and/or deflect impinging electromagnetic radiation, to an ink such as an inkjet ink that is used in inkjet personalization. Such a personalization is preferably printed on the top of the card body, i.e. on the uppermost surface of the card body. In this case an undetected removal of the protection element, e.g. of the reactive medium, from the card body surface is rendered impossible as the personalization would be damaged and is thus made visible.

The at least one protection element preferably comprises at least one of waxes, silicone-containing materials, UV absorbers such as 2-hydroxyphenyl-s-triazines and their derivatives, IR absorbers, and thermosets, preferably curable thermosets such as a compound comprising UV-curable [meth]-acrylates, epoxides and/or vinylethers.

These components are likewise commercially available. For example, spectraCARD IRB, MSD4800 and MSC3600 could be used as IR absorber. Conceivable UV absorbers are based on the 2-hydroxyphenyl-s-triazine derivative which is known as Tinuvin® 1600 from the company BASF, or are hydroxyphenyl benzotriazole class UV absorbers such as Tinuvin® 360 from the company BASF or are benzoxazinone based UV absorbers such as Cyasorb® UV-3638F from the company Solvay. Particularly preferably a combination between one or more of the waxes and silicone-containing materials on the one hand side and one or more of the UV absorbers, the IR absorbers and the thermosets on the other hand side are used for providing the protection element. That is, it is particularly preferred to provide the protection element as a combination of chemically different materials. In this case local adhesion weaknesses between the layers (artificial bonding weaknesses) can be created by introducing chemically different compositions. Against this background such an adhesion weakness can be provided in the form of a foreign layer being based on one or more waxes or silicon-comprising materials which exhibit an adhesion-inhibiting effect, wherein the binding agents are based on the UV absorbers, the IR absorbers and the thermosets, respectively.

The least one protection element can be provided in the form of a dot grid on the card body, wherein the dots constituting the grid preferably comprise a varnish and the at least one protection element.

That is to say, the protection element can be provided intermittent on the card body and is preferably combined, in particular dispersed in a varnish or an ink layer. This is in contrast to a full-surface application of the protection element on the card body. A dot grid corresponds to individual drops that are arranged next to one another so as to produce a regular or irregular pattern. The varnish is preferably a commercially available varnish known in the state of the art, for example an inkjet varnish for plastic cards.

The data carrier can comprise one or more cover layers that are arranged on the card body, and wherein the at least one protection element is provided in the one or more cover layers and/or on the one or more cover layers.

Hence, instead of providing the protection element in the form of drops it is likewise conceivable to provide the protection element in a layer or layers and/or on a layer or layers, respectively. If these one or more layers are arranged on the card body, in particular on the uppermost surface of the card body, these one or more layers are referred to as cover layer.

The one or more cover layers preferably comprise at least one of a varnish, an ink layer, polycarbonate, polyvinyl chloride, polyester, in particular amorphous polyester and/or co-polyester and/or semi-crystalline polyester. These components are again commercially available components known in the state of the art.

The at least one protection element can provided as an imprint in a surface of the one or more cover layers and/or as one or more particles that are incorporated into the one or more cover layers.

The imprint serves the purpose of diffracting impinging electromagnetic radiation such, that a subsequent laser marking has no defined shape but appears blurry or fuzzy, see above. Likewise, the one or more particles result in a diffraction of impinging electromagnetic radiation in the event of a subsequent laser marking. The one or more particles preferably are nanoparticles, particularly preferably silicon dioxide and/or titanium dioxide.

The at least one protection element can be provided between at least two subsequently arranged cover layers in one or more regions, wherein the adhesive force exerted by the at least one protection element to the at least two subsequently arranged cover layers in said one or more regions is smaller than an adhesive force exhibited between other regions between the at least two subsequently arranged cover layers where no protection element is present. Instead of an adhesive force exerted by the protection element being lower than an adhesive force exerted by its surroundings it is likewise possible that the protection element does not exert any adhesive force at all.

The at least one protection element preferably comprises at least one of waxes, silicone-containing materials, UV absorbers such as 2-hydroxyphenyl-s-triazines and their derivatives, IR absorbers, and thermosets, preferably curable thermosets such as a compound comprising UV-curable [meth]-acrylates, epoxides and/or vinylethers as mentioned above. That is, it is preferred to generate artificial bonding weaknesses between the cover layers.

A surface of the card body facing the one or more cover layers can comprise one or more elevations and recesses. These elevations and recesses can be seen as an anchorage that improves the attachment of the cover layer(s) to the card body. Said elevations and recesses could be produced during a lamination process that is performed upon the generation of the card body. Additionally or alternatively one or more diffractive elements could be provided in one or more of the cover layers.

Said diffractive elements are preferably generated in an uppermost surface of the cover layer facing towards an outside of the data carrier. The provision of diffractive elements likewise render a removal of the protection element for counterfeiting purposes more obvious. The diffractive elements can correspond to diffractive structures as they are known in the art. For example, a diffractive structure could be generated which produces rainbow colors or other visual effects when the data carrier is observed under daylight or upon illumination. Additionally or alternatively one or more visual elements, preferably one or more colour images, particularly preferably one or more inkjet colour images, could be provided in one or more of the cover layers. These one or more visual elements preferably comprise a protection element such as the laser reactive medium or the one or more particles mentioned above.

It should be noted that the data carrier can comprise only one protection element or two or more protection elements. Said two or more protection elements can be of the same type or of different types.

In a further aspect a security document is provided, wherein the security document comprises a data carrier as described above. The security document preferably is an identity card, a passport, a credit card, a bank note or the like. At this point it should be understood that the data carrier per se can correspond to a security document. This is the case if the data carrier is provided in the form of an identity card, for example. However, it is likewise conceivable to introduce or incorporate the data carrier into a security document. In the case of a passport for example the data carrier could correspond to a page of the passport, within which the card body with protection element(s) are arranged.

In a further aspect a method of producing a data carrier, preferably a data carrier as described above is provided. The method comprises the steps of i) providing a card body and ii) providing at least one protection element. The card body is configured to interact with impinging electromagnetic radiation such, that a laser marking having a first appearance is previously generated in the card body in the region of impingement in the absence of a protection element. The at least one protection element is configured to interact with impinging electromagnetic radiation such, that a laser marking having a second appearance is generated in the card body, wherein said second appearance differs from the first appearance.

In use, the originator such as passport authorities or banks preferably generates the laser marking having the first appearance, i.e. the original laser marking, in the card body in a first step. In a subsequent second step, one or more protection elements as described above are added to the card body. As the protection element alters the appearance of any further laser manipulations, a subsequent laser marking by a forger becomes readily apparent.

In particular, the at least one protection element could be added to at least one of a varnish, an ink layer, polycarbonate, polyvinyl chloride, and polyester, in particular amorphous polyester and/or co-polyester and/or semi-crystalline polyester, so as to form a mixture, and wherein said mixture is applied onto the card body. Additionally or alternatively at least one of a varnish, an ink layer, polycarbonate, polyvinyl chloride, and polyester, in particular amorphous polyester and/or co-polyester and/or semi-crystalline polyester are applied onto the card body so as to form one or more cover layers, and wherein the at least one protection element is formed as an imprint in a surface of the one or more cover layers, and/or wherein at least one of a varnish, an ink layer, polycarbonate, polyvinyl chloride, and polyester, in particular amorphous polyester and/or co-polyester and/or semi-crystalline polyester can be applied onto the card body so as to form two or more cover layers, and wherein the at least one protection element is provided between at least two subsequently arranged cover layers in sections.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1a shows a plan view on a data carrier comprising an original laser marking in the form of an image;

FIG. 1b shows a plan view on data carrier comprising an original laser marking in the form of an image and a forged laser marking in the form of glasses;

FIG. 1c shows a plan view on a data carrier comprising an original laser marking in the form of an image, at least one protection element, and a forged laser marking in the form of glasses;

FIG. 1d shows a plan view on a data carrier comprising an original laser marking in the form of an image, at least one protection element according to a further embodiment, and a forged laser marking in the form of glasses;

FIG. 2 shows an exploded sectional view through a data carrier comprising an original laser marking and a protection element during an attempt of forgery;

FIG. 3 shows an exploded sectional view through a data carrier according to another embodiment comprising an original laser marking and a protection element according to another embodiment during an attempt of forgery;

FIG. 4 shows an exploded sectional view through a data carrier according to another embodiment comprising an original laser marking and a protection element according to another embodiment during an attempt of forgery;

FIG. 5 shows a plan view on a surface of a data carrier comprising a protection element in the form of a dot grid.

### DESCRIPTION OF PREFERRED EMBODIMENTS

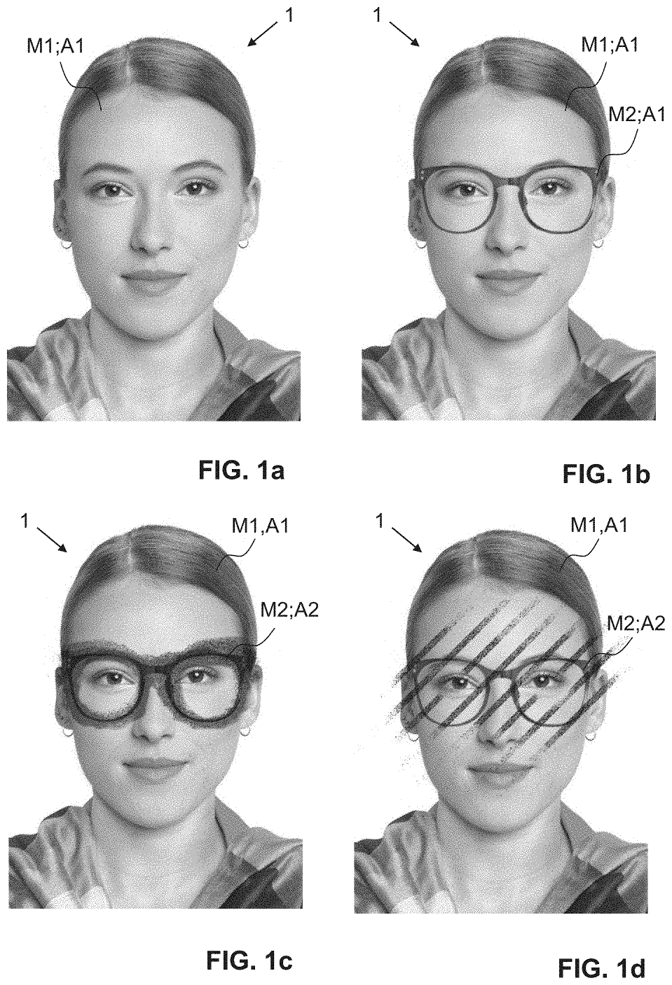

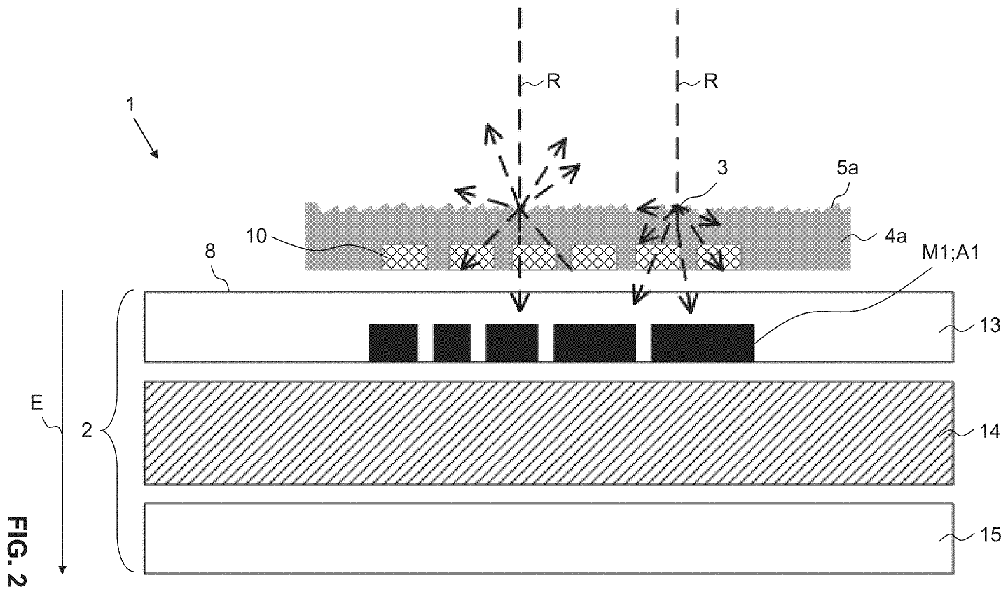

FIGS. 1a to 1d shall illustrate the effect of the invention. Namely, FIG. 1a depicts a data carrier 1 comprising a card body 2 that has a laser marking M1 in the form of an image. The image M1 corresponds here to a photograph that could be provided in a security document such as a passport or identity card. This data carrier 1 corresponds to an original, i.e. a genuine data carrier 1. In the absence of one or more protection elements 3 according to the invention, a forger can manipulate said laser marking M1 in the form of the image by adding further elements. This situation is depicted in FIG. 1b, wherein a forger has added a further laser marking M2 in the form of glasses. Since the original laser marking M1 and the forged laser marking M2 are of a same appearance A1, A2, here of a sharp and well defined structure, there is a high risk that the forgery will not be detected. However, in the presence of at least one protection element 3 according to the invention, the forged laser marking M2 will be readily recognizable as a forged laser marking as it is of a different appearance A2 than the original laser marking M1, see FIGS. 1c and 1d. Namely, a forgery of the data carrier 1 comprising a protection element 3 according to FIG. 1c results in bubbling, bulging, blurry and fuzzy effects and a forgery of the data carrier 1 comprising a protection element 3 according to FIG. 1d results in a laser marking M2 having a “bleeding” appearance A2, respectively. With respect to FIGS. 2 to 4 the elements causing these effects are explained in greater detail.

That is, FIGS. 2 to 4 in each case depict a data carrier 1 that comprises a card body 2. The card body 2 in turn comprises several layers 13, 14, 15 that are stacked on top of each other. To this end the layers 13, 14, 15 correspond to layers that are well-known in the state of the art. Moreover, at least one of the layers, here the top layer 13 of the card body 2, comprises a material that is configured to interact with electromagnetic radiation such that a laser marking is generated. This layer 13 is therefore referred to as processing layer. In the present example said processing layer 13 is made of a transparent polycarbonate film. Below the processing layer 13 there is arranged a layer 14 being made of an opaque polycarbonate film. Below said opaque film 14 there is again arranged a transparent layer 15 made of a polycarbonate film. Hence, the card body 2 depicted in these embodiments consists of three layers 13, 14, 15 that are subsequently arranged along an extension direction E, wherein the uppermost layer 13 is constituted by the processing layer. The data carriers 1 according to FIGS. 2 to 4 differ from one another especially in their protection element 3. In these examples, the protection elements 3 have been added to the data carrier 1 after the data carrier 1 has been provided with its original laser marking M1 having a first appearance A1.

The data carrier 1 according to FIG. 2 comprises a cover layer 4a that is arranged on an uppermost surface 8 of the data carrier 1, here on a top surface 8 of the processing layer 13. The cover layer 4a is made of at least one of a varnish, an ink layer, polycarbonate, polyvinyl chloride, and polyester and comprises a protection element 3 in the form of an imprint 5a in its top surface 8. Said imprint 5a is typically made by using an embossing stamp with patterns having gratings in the dimensional scale to influence impinging radiation R and is configured to diffract, scatter and deflect impinging electromagnetic radiation R in the event of a subsequent counterfeiting laser marking. Due to this diffraction, scattering, deflection, etc. it is no longer possible to generate a laser marking that has the same appearance as the original laser marking. Instead, a blurry and fuzzy laser marking such as the glasses M2; A2 depicted in FIG. 1c is generated. Said cover layer 4a additionally comprises visual elements 10 in the form of an original inkjet color image. If a forger tries to get rid of the protection element 3 by removing the cover layer 4a, the visual elements 10 would be destroyed, thereby making the attempt of forgery evident. Further elements that make a removal of the protection element 3 obvious are, for example, the provision of a diffractive element in the cover layer 4a, wherein said diffractive element causes light diffractive visual effects that are indicative of the presence of the protection element 3. The diffractive visual effects are typically in the wavelength of the visible light and the protection element in the wavelength of the impinging radiation R. They can be partly in the same range of wavelength. Typically, they are located on the surface in an alternating way.

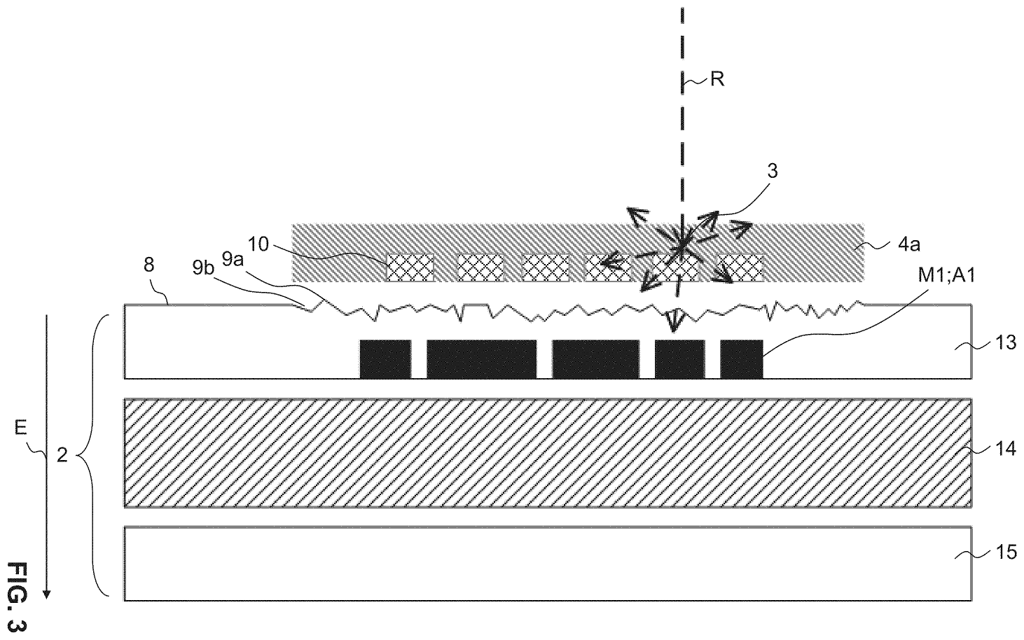

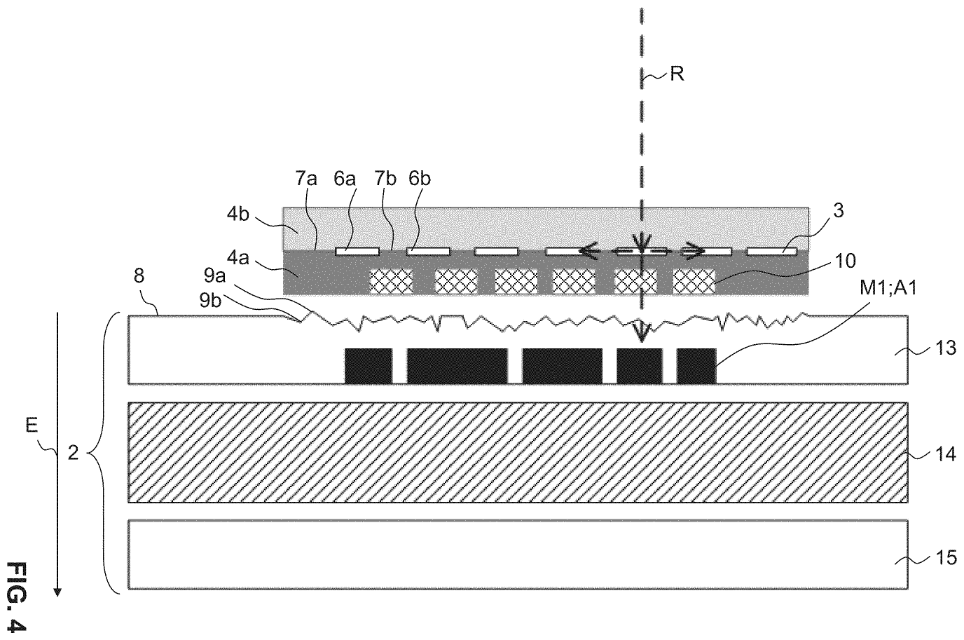

The data carrier 1 according to FIG. 3 comprises a cover layer 4a that is arranged on an uppermost surface 8 of the data carrier 1, here again on the top surface 8 of the processing layer 13. The cover layer 4a is made of at least one of a varnish, an ink layer, polycarbonate, polyvinyl chloride, and polyester and comprises a protection element 3 that is provided within the cover layer 4a. Said protection element 3 can correspond to a laser reactive medium and/or to a perturbing medium that perturbs an impinging beam of electromagnetic radiation R. The laser reactive medium according to the former case is configured to generate one or more gases upon an interaction with electromagnetic radiation R and corresponds to at least one of a laser reactive pigment, laser reactive additive, and laser reactive colorant. Hence, if a forger irradiates electromagnetic radiation R in an attempt of forgery, the laser reactive medium generates gases which lead to bubbles and bulges in the data carrier 1. This laser reactive medium can be incorporated into the material that constitutes the cover layer 4a. However, it is likewise conceivable to add the laser reactive medium to another component that is introduced into the data carrier 1, such as into the inkjet ink that is used for generating the visual elements 10 constituting an inkjet color picture, for example. The perturbing medium according to the latter case is configured to diffract and/or scatter and/or deflect impinging electromagnetic radiation R and corresponds to one or more particles, preferably nanoparticles such as silicon dioxide and/or titanium dioxide nanoparticles that are incorporated into the cover layer 4a. In an attempt of forgery the irradiated electromagnetic radiation R will be perturbed by said particles such, that the generation of a well-defined or sharp laser marking is prevented. Instead, a blurry and fuzzy laser marking is produced. In order to enhance the attachment of the cover layer to the card body 2 of the data carrier 1 a surface 8 of the card body 2 facing the cover layer 4a, here the top surface 8 of the processing layer 13, comprises several elevations and recesses 9a, 9b. This irregular surface structure enhances an adhesive force established between the cover layer 4a and the processing layer 13. Besides, if the cover layer 4a comprises a visual element 10 made of an ink as it is presently the case, then said surface structure 9a, 9b also acts as an ink anchorage as it enhances an attachment of the ink to the surface 8 of the processing layer 13. It should be noted that such an irregular surface structure can likewise be present in the data carrier 1 according to FIG. 2 or 4.

The data carrier 1 depicted in FIG. 4 comprises two cover layers 4a, 4b that are arranged above one another. The lower cover layer 4a is attached to the uppermost surface 8 of the card body 2, here the top surface 8 of the processing layer 13, as it is the case in the data carrier 1 according to FIG. 2. In the data carrier 1 according to FIG. 4 the two cover layers 4a, 4b again comprise at least one of a varnish, an ink layer, polycarbonate, polyvinyl chloride, and polyester. Furthermore, the protection element 3 is arranged between the two cover layers 4a, 4b. In particular, the protection element 3 is arranged in sections such that in some regions 6a, 6b between the two cover layers 4a, 4b a protection element 3 is present whereas in other regions 7a, 7b no protection element 3 is present. In the latter case the two cover layers 4a, 4b preferably lie directly on top of one another. An adhesive force established between the cover layers 4a, 4b is lower in the regions 6a, 6b in which the protection element 3 is present as compared to the regions 7a, 7b where no protection element 3 is present. It is even conceivable that no adhesive force is established between the cover layers 4a, 4b in the regions 6a, 6b in which the protection element 3 is present. In this case, the two cover layers 4a, 4b are held together by the adhesion exerted in the regions 7a, 7b having no protection element 3. Hence, it can be said that the protection element 3 providing a low adhesive force or no adhesive force results in a bonding weakness between the cover layers 4a, 4b. In any case, the protection element 3 is furthermore configured to absorb impinging electromagnetic radiation R. Because of the strong absorption properties an increased local heating of the protection element 3 and a resulting material combustion of the material constituting the protection element 3 is achieved. This so-called “bleeding” can manifest itself by black stripes as depicted in FIG. 1d, for example. The protection element 3 preferably comprises waxes, silicone-containing compounds and thermosets that are mixed with one or more compounds selected from UV absorbers, IR absorbers. It is noted that the cover layers 4a, 4b, in the present example only the cover layer 4a, can also comprise visual elements 10 such as original inkjet color images that optionally comprise a laser reactive medium and/or perturbing particles as described above.

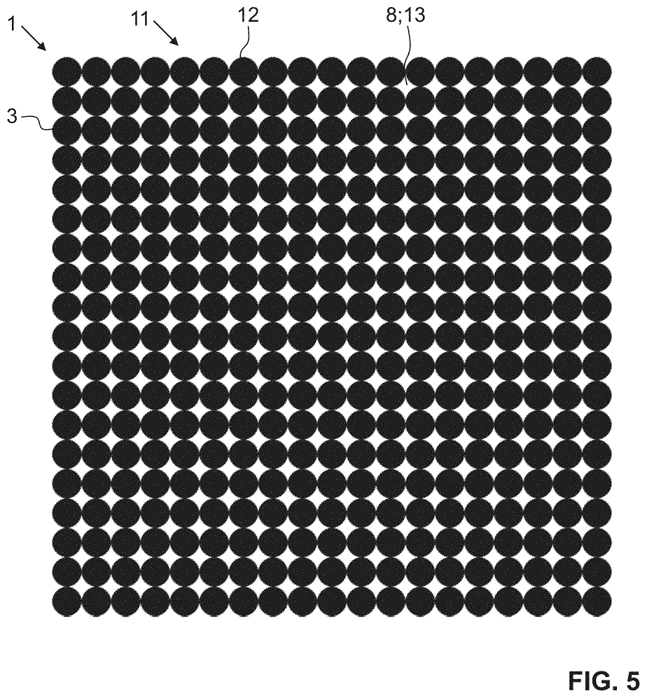

The data carriers 1 discussed to this end in each case comprise a protection element 3 that is added onto or provided within a cover layer 4a, 4b, wherein the cover layer 4a, 4b is a layer that extends over an entire surface of the card body 2, in particular over the entire top surface 8 of the processing layer 13. However, it is likewise conceivable that said layer 4a, 4b extends only partly over the surface 8 of the card body 2. Moreover, instead of on or within a cover layer 4a, 4b, the protection element 3 could also be provided in a patterned manner, i.e. in a discontinuous manner. For example, the protection element 3 in the form of a laser reactive medium and/or perturbing particles could be mixed with a varnish that is then distributed over the uppermost surface 8 of the card body 2, in particular the top surface 8 of the processing layer 13, see FIG. 5.

### LIST OF REFERENCE SIGNS

1 data carrier
2 card body
3 protection element
4a, 4b cover layer
5a, 5b imprint
6a, 6b region
7a, 7b region
8 surface
9a elevation
9b recess
10 visual element
11 dot grid
12 dots
13 layer
14 layer
15 layer
R electromagnetic radiation
M1 laser marking
M2 laser marking
A1 first appearance
A2 second appearance
E extension direction

1. A data carrier (1) comprising a card body (2),
wherein the card body (2) is configured to interact with impinging electromagnetic radiation (R) such, that a laser marking (M1) having a first appearance (A1) is generated in the card body (2) in region of impingement,
wherein the data carrier (1) further comprises at least one protection element (3),
wherein the at least one protection element (3) is configured to interact with impinging electromagnetic radiation (R) such, that a laser marking (M2) having a second appearance (A2) is generated in the card body (2), wherein said second appearance (A2) differs from the first appearance (A1).

2. The data carrier (1) according to claim 1, wherein the at least one protection element (3) is configured to generate one or more gases upon an interaction with electromagnetic radiation (R).

3. The data carrier (1) according to claim 2, wherein the at least one protection element (3) is configured to diffract and/or scatter and/or deflect impinging electromagnetic radiation.

4. The data carrier (1) according to claim 3, wherein the at least one protection element (3) is configured to absorb electromagnetic radiation (R), preferably electromagnetic radiation (R) being in the ultraviolet region and/or in the infrared region of the electromagnetic spectrum, and/or wherein the at least one protection element (3) is configured to exhibit an adhesive force or no adhesive force.

5. The data carrier (1) according to claim 4, wherein the at least one protection element (3) comprises at least one of a laser reactive pigment, laser reactive additive, and laser reactive colorant.

6. The data carrier (1) according to claim 5, further comprising at least one personalization item that is an alphanumeric character or an image, and wherein the personalization item comprises the at least one protection element (3) and an ink, preferably an inkjet ink.

7. The data carrier (1) according to claim 6, wherein the at least one protection element (3) comprises at least one of waxes, silicone-containing materials, UV absorbers such as 2-hydroxyphenyl-s-triazines and their derivatives, IR absorbers, and thermosets, preferably curable thermosets such as a compound comprising UV-curable [meth]-acrylates, epoxides and/or vinylethers.

8. The data carrier (1) according to claim 7, wherein the at least one protection element (3) is provided in the form of a dot grid (11) on the card body (2), wherein the dots (12) constituting the grid preferably comprise a varnish and the at least one protection element (3).

9. The data carrier (1) according to claim 8, wherein the data carrier (1) comprises one or more cover layers (4a, 4b, . . . ) that are arranged on the card body (2), and
wherein the at least one protection element (3) is provided in the one or more cover layers (4a, 4b, . . . ) and/or on the one or more cover layers (4a, 4b, . . . ), and wherein the one or more cover layers (4a, 4b, . . . ) preferably comprise at least one of a varnish, an ink layer, polycarbonate, polyvinyl chloride, polyester, in particular amorphous polyester and/or co-polyester and/or semi-crystalline polyester.

10. The data carrier (1) according to claim 9, wherein the at least one protection element (3) is provided as an imprint in a surface (5a, 5b, . . . ) of the one or more cover layers (4a, 4b) and/or as one or more particles that are incorporated into the one or more cover layers (4a, 4b), the one or more particles preferably being nanoparticles, particularly preferably silicon dioxide and/or titanium dioxide.

11. The data carrier (1) according to claim 10, wherein the at least one protection element (3) is provided between at least two subsequently arranged cover layers (4a, 4b, . . . ) in one or more regions (6a, 6b, . . . ), wherein the adhesive force exerted by the at least one protection element (3) to the at least two subsequently arranged cover layers in said one or more regions is smaller than an adhesive force exhibited between other regions (7a, 7b, . . . ) between the at least two subsequently arranged cover layers where no protection element (3) is present.

12. The data carrier (1) according to claim 11, wherein a surface (8) of the card body (2) facing the one or more cover layers (4a, 4b, . . . ) comprises one or more elevations and recesses (9a, 9b), and/or
wherein one or more diffractive elements are provided in one or more of the cover layers, and/or
wherein one or more visual elements (10), preferably one or more colour images, particularly preferably one or more inkjet colour images, are provided in one or more of the cover layers (4a, 4b, . . . ).

13. The data carrier of claim 1 is embodied in a security document that is one of an identity card, a passport, a credit card, or a bank note.

14. A method of producing a data carrier (1), comprising the steps of:
Providing a card body (2);
Providing at least one protection element (3);
wherein the card body (2) is configured to interact with impinging electromagnetic radiation (R) such, that a laser marking (M1) having a first appearance (A1) is generated in the card body (2) in the region of impingement,
wherein the at least one protection element (3) is configured to interact with impinging electromagnetic radiation (R) such, that a laser marking (M2) having a second appearance (A2) is generated in the card body (2), wherein said second appearance (A2) differs from the first appearance (A1).

15. The method according to claim 14, wherein the at least one protection element (3) is added to at least one of a varnish, an ink layer, polycarbonate, PVC, and polyester, in particular amorphous polyester and/or co-polyester and/or semi-crystalline polyester, so as to form a mixture, and wherein said mixture is applied onto the card body (2).

16. The method according to claim 15, and
wherein at least one of a varnish, an ink layer, polycarbonate, polyvinyl chloride, and polyester, in particular amorphous polyester and/or co-polyester and/or semi-crystalline polyester are applied onto the card body (2) so as to form one or more cover layers (4a, 4b, . . . ), and wherein the at least one protection element (3) is formed as an imprint in a surface (5a, 5b, . . . ) of the one or more cover layers (4a, 4b, . . . ).

17. The method according to claim 16, and
wherein at least one of a varnish, an ink layer, polycarbonate, polyvinyl chloride, and polyester, in particular amorphous polyester and/or co-polyester and/or semi-crystalline polyester are applied onto the card body (2) so as to form two or more cover layers (4a, 4b, . . . ), and wherein the at least one protection element (3) is at least partially provided between at least two subsequently arranged cover layers (4a, 4b, . . . ).
